(19) United States
(12) Patent Application Publication
(10) Pub. No.: US 2003/0041899 A1
(43) Pub. Date: Mar. 6, 2003

(54) Pressurized gas canister

(75) Inventor: Kenneth Frank, Kearney, NE (US)

Correspondence Address: LEYDIG, VOIT & MAYER, LTD., (SEATTLE OFFICE), TWO PRUDENTIAL PLAZA, SUITE 4900, CHICAGO, IL, 60601-6780, US

(73) Assignee: The Coleman Company, Inc.

(21) Appl. No.: 09/945,506

(22) Filed: Sep. 4, 2001

(51) Int. Cl. F16K 17/14

(52) U.S. Cl. 137/74

(57) ABSTRACT

A canister such as may be used for storing metal hydride. The canister includes a thermal fuse designed to relieve pressure in the canister when the temperature of the canister exceeds a threshold, for example, as a result of fire or direct heating. In addition, a latching assembly provides a quick-release connection for securely and reliably attaching the canister to a fuel delivery system, such as an input manifold for a fuel cell.

### FIELD OF THE INVENTION

The present invention relates to pressurized-gas canisters, and more particularly to metal hydride canisters.

### BACKGROUND OF THE INVENTION

Electric power is ubiquitous in modern society, providing energy for many of the conveniences that have accompanied the industrial revolution. A major enabling factor supporting the growth of the national and world economy is the ready availability of a source of electric power. Moreover, the need for a reliable and continuous source of electricity is growing as the economy, both locally and internationally, becomes dependent on information and communications technology. In industrialized nations, most of the electric power is distributed through an energy grid wherein electricity is generated in large power plants that are interconnected with each other and with the customers, or users, of the electricity. The centralized power plant model is remarkably efficient, permitting power generation plants to benefit from economies of scale and to select power generation equipment that is suited to the projected need and resources available.

A disadvantage of the centralized power plant system is that the user is typically completely reliant on the central power generator and the stability of the power grid. The electric power grid is, however, subject to outages that may result from many different causes, such as natural disasters, human errors, over-demand, power plant maintenance requirements, and the like. When the power grid (or more precisely, a portion of the grid) goes down, it typically happens without warning. The impact of such outages can vary from inconvenience to life-threatening. The lack of warning can be particularly disadvantageous in computer-related applications, wherein a sudden loss of power can result in significant and unrecoverable losses of data, as well as damage to sensitive equipment.

Critical applications, such as hospitals, and nuclear power plant emergency systems, typically maintain secondary emergency power generators that are designed to come on line automatically when the local power grid goes down. Emergency power generators may comprise large banks of batteries and/or gas or diesel powered engines that drive electric generators. These types of emergency power generators are expensive, generate undesirable byproducts such as carbon monoxide and nitrous oxide, are complicated mechanical devices that are subject to failure, and/or utilize hazardous materials such as lead, motor oil, oil filters and the like that may present a health risk and are difficult to dispose properly. A further disadvantage of battery-based emergency power systems is that the batteries have a relatively short useful life before they must be recharged.

Small gas-powered emergency power generators are available for individual users or other less-demanding applications. Examples of such independent power sources include Coleman Powermate's POWERSTATION line of generators. Battery-powered emergency power systems, often termed “uninterruptible power supplies” are also well-known in the art.

Fuel cell electric power generators provide a direct energy conversion alternative to conventional electric power generators. In a typical fuel cell, a gaseous fuel is fed continuously to an anode and an oxidant is fed continuously to a cathode. An electrochemical reaction takes place at the electrodes to produce an electric current. Several different types of fuel cells are known, including polymer electrolyte fuel cells, alkaline fuel cells, phosphoric acid fuel cells, molten carbonate fuel cells and solid oxide fuel cells.

In a fuel cell utilizing hydrogen gas as the fuel, electricity is generated by the disassociation of a hydrogen atom's electron from its proton and the eventual combination of the proton and an electron with oxygen atoms to create pure water and heat. This electrochemical reaction may be usefully accomplished using a proton exchange membrane (PEM) electrolyte sandwiched between electrodes plated with a catalyst, such as platinum. On either side of the PEM, hydrogen and oxygen are introduced next to the anode and cathode, respectively. Protons from disassociated hydrogen atoms at the anode migrate through the PEM to the oxygen-containing cathode side, thereby creating an electrical potential. The electrical potential induces a current through the circuit connecting the anode and cathode, as the free electron from the hydrogen travels from the anode to the cathode.

A fuel cell stack is a collection of individual fuel cells, each of which includes its own cathode, anode, and proton exchange membrane. The power output characteristics of a fuel cell depend on the particular fuel cell design. Stacking fuel cells permits the designer to achieve the total power output desired. Unlike batteries, which discharge over time, and must be recharged or replaced periodically, a fuel cell continues to generate electricity as long as it has both oxygen and hydrogen.

The advantages of fuel cell technology are several. A fuel cell utilizing hydrogen fuel generates electricity without combusting the hydrogen and creates no toxic exhaust. Therefore fuel cell generators are very environmentally friendly and can be used indoors. Fuel cells can be designed that operate at or near room temperature. Fuel cell generators have few moving parts and therefore they are very quiet and reliable. Fuel cell generator power output is stable and reliable as long as hydrogen and oxygen are supplied, and the power output is scaleable in a very straightforward manner.

Often, hydrogen for a fuel cell is stored in a hydrogen storage alloy. Hydrogen storage alloys are well known in the art, and have the ability to releasably absorb hydrogen, forming a metal hydride. The reaction of hydrogen with the metal alloy is reversible and is a function of pressure and temperature. Metal hydrides provide a superior reservoir of hydrogen, because the hydrogen density in metal hydrides can be significantly greater than for gaseous or liquid hydrogen, and the hydrogen can be stored at relatively low pressures and moderate temperatures.

Typically, metal hydride for a fuel cell is provided in a canister or a plurality of canisters. Metal hydride canisters differ from typical high-pressure gas canisters in that the metal hydride disassociates within the canister into hydrogen gas and the metal ion, and the metal ion remains in the canister after the hydrogen gas is removed. The metal ion may be re-hydridized as a way to recharge the canister for future use. To this end, the metal hydride canisters are typically releasably connected to the fuel cell so that the canisters may be released and refueled with hydrogen.

### SUMMARY OF THE INVENTION

The present invention is directed to pressurized-gas canisters, and more specifically to an improved metal hydride canister. In accordance with one aspect of the present invention, a metal hydride canister is provided with a thermal fuse designed to relieve pressure in the canister when the temperature of the canister exceeds a threshold, for example, as a result of fire or direct heating.

In accordance with another aspect of the present invention, the canister includes a quick-release connection for attaching the canister to gas consumer, such as a fuel cell. The quick-release connection may be, for example, a slide plate connected to a button that is mounted on a handle of the canister. The slide plate includes an opening having a narrow portion and a wider portion. Actuating the button moves the slide plate so that the wide portion is aligned with a female connection port. Releasing the button aligns the narrow portion of the opening with the female connection port.

The quick release mechanism is designed to latch onto a male coupling that is in fluid communication with the fuel cell. The male coupling may be, for example, cylindrical in shape. The male coupling includes a shoulder behind which fits the narrow portion of the opening of the slide plate when the male coupling is in the female connection port and when the button is released.

The narrow portion and the wide portion of the opening are configured so that the male coupling fits through the wide portion, but does not fit through the narrow portion. Pressing the button causes the wide portion of the opening to align with the female connection port, permitting the male coupling to be inserted through the wide portion and into the female connection port. Releasing the button permits the narrow portion to fit behind the shoulder on the male coupling. Pressing the latch button again permits the male coupling to be released.

Other advantages will become apparent from the following detailed description when taken in conjunction with the drawings, in which:

### BRIEF DESCRIPTION OF THE DRAWINGS

FIG. 1 is a perspective view of a canister incorporating the present invention;

FIG. 2 is an exploded perspective view of the top portion of the canister of FIG. 1;

FIG. 3 is a perspective view showing connection of the canister of FIG. 1 to one of three solenoid valves that are used to feed hydrogen to a fuel cell;

FIG. 4 is a partial cross-sectional view of the top portion of the canister of FIG. 1, showing actuation of a button on the canister prior to inserting a male coupling into a female connection port on the canister;

FIG. 5 is a partial cross-sectional view of the top portion of the canister of FIG. 1, similar to FIG. 4, showing the male coupling inserted into the female connection port;

FIG. 6 is a partial cross-sectional view of the top portion of the canister of FIG. 1, similar to FIGS. 4 and 5, showing release of the button on the canister to latch the male coupling into the female connection port on the canister;

FIG. 7 is a bottom exploded perspective view of a valve body for use in the canister of FIG. 1, showing a slide plate and thermal fuse that are attached to the valve body; and

FIG. 8 is cross-sectional view of the valve body of FIG. 7, taken along the section lines 8-8 of FIG. 7.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details. Furthermore, well-known features may be omitted or simplified in order not to obscure the present invention. In addition, to the extent that orientations of the invention are described, such as “top,” “bottom,” “front,” “bottom,” and the like, the orientations are to aid the reader in understanding the invention, and are not meant to be limiting.

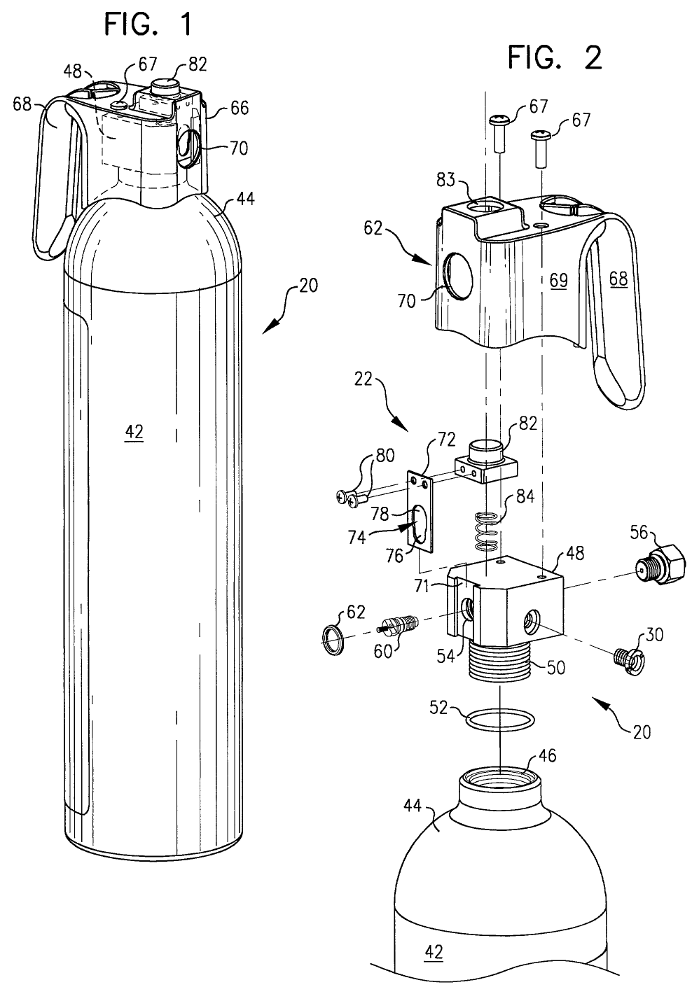

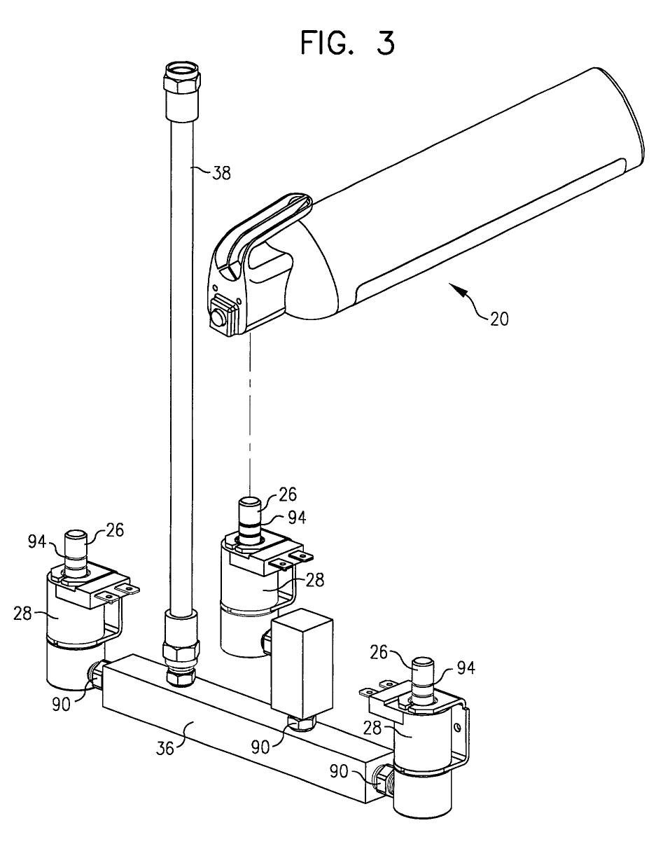

Briefly described, with reference to FIG. 1, the present invention provides a canister 20 for use, for example, in storing metal hydride. The canister 20 includes a novel latching assembly 22 (FIG. 2) for removably attaching the canister 20 to a male coupling, for example a male coupling 26 extending from a solenoid valve 28 (FIG. 3). In addition, the canister 20 includes a thermal fuse 30 (FIG. 2) in fluid communication with the interior of the canister. The functions and operations of the latching assembly 22 and the thermal fuse 30 are described further below.

Although the canister 20 described herein may be used for many different applications, it is particularly well suited for use in pressurized gas applications. More particularly, the present invention has particular application for use in storage of metal hydride. In one application, for example, the canister 20 stores metal hydride and is connected to a fuel cell. The metal hydride within the canister 20 disassociates to form hydrogen which is used in the electrochemical reaction within the fuel cell.

The canister 20 may be connected, for example, to a fuel cell (not shown, but known in the art) via a manifold 36 (FIG. 3). The manifold 36 supplies a supply of hydrogen to the fuel cell via a conduit 38. A series of the solenoid valves 28 are connected to the manifold 36. In this manner, separate canisters 20 may be attached to each of the solenoid valves 28. By utilizing multiple metal hydride canisters 20, the amount of hydrogen required from any one canister 20 is reduced, thereby limiting the amount of cooling in any canister 20. Multiple canisters 20 also facilitate heat transfer into the metal hydride by providing a large surface area to volume ratio.

Returning now to FIG. 2, the canister includes a tank 42, preferably formed of aluminum or another suitable material that complies with DOT 3AL regulations. If used for metal hydride storage, the tank 42 may include one of many metal hydride formulations, including among others the AB, AB2, and AB5 hydride families, which are designed to operate in standard atmospheric conditions with various operating parameters, such as hydrogen storage capacity.

The tank 42 includes a tapered top end 44 having a threaded opening 46. If used for metal hydride storage, the tank 42 may include a heat transfer/decrepitation device (not shown), along with the metal hydride, to aid in heat transfer from the walls of the cylinder to the hydride bed. Temperature equalization is important to metal hydride canister usage because the metal hydride cools down as hydrogen is released. The release of the hydrogen is an endothermic reaction which rapidly cools the interior of the tank 42. Metal hydride is a poor thermal conductor resulting in a thermal gradient from the center of the tank 42 to the walls of the tank. Efficient release of the hydrogen from the metal hydride requires equalization of the metal hydride temperature.

In one example, the heat transfer/decrepitation device may include, for example, a brush having a stem with bristles made of a material with good heat transfer characteristics. The brush also aids in reducing compaction of the hydride powder. Other means can also be used to produce the same results as a brush. The brush may also be designed so that it may bend as it is inserted into the tank 42 through the threaded opening 46 and spring back to its initial shape once past the opening. The bristles of the brush preferably contact the inside of the tank 42 when the brush is inside the canister. An example of brush would have bristles made of an aluminum alloy or of brass, crafted into the stiffest and finest wire possible.

The canister 20 includes a valve body 48 having a threaded shaft 50 configured to screw into the threaded opening 46. An o-ring 52 fits around the threaded shaft 50 to prevent air leakage from the fitting. Generally, a valve body is a structure consisting of one or more parts into which at least one valve or similar functioning device is mounted. To this end, in accordance with one aspect of the present invention, the thermal fuse 30 is considered a similar functioning device, although other valves are described as being mounted in the valve body, as further described below.

The valve body 48 is shaped like a block, with the threaded shaft 50 extending out of its lower end, and a female connection port 54 extending into its front face. A vent mechanism 56 is included and is attached to the rear end of the valve body 48. The vent mechanism 56 may automatically activate and relieve internal pressure inside the canister if internal pressure exceeds a pre-determined level. Examples of vent mechanism 56 include, for example, a pressure relief valve, a rupture disk, a fusible plug, or a combination of similar such devices to comply with Compressed Gas Association Standards. The vent mechanism 56 and the female connection port 54 are in fluid communication with the inside of the tank, as is described further below.

The exemplary embodiment of FIG. 1 also shows a female delivery valve mechanism 60 that is recessed, for example, inside the female connection port 54 of the valve body 48. The delivery valve mechanism 60 may be a mechanically-activated valve that acts as the main interconnection between canister 20 and the male coupling 26 of one of the solenoid valves 28 as shown in FIG. 4. An exemplary embodiment of the delivery valve mechanism 60 may be the commercially-available valve known widely as a “Schrader” valve, manufactured by Schrader-Bridgeport, Inc. An quad-ring or T-seal 62 is provided in the end of the female connection port 54.

The canister 20 includes a handle 66 attached to the top of the valve body 48, for example by a pair of fasteners 67. The handle 66 acts as a carrying device for the canister 20, and as a protection device for the interconnection between the male coupling 26 and the female connection port 54, protecting it from physical damage and accidental disengagement. The handle includes a gripping portion 68 and a housing portion 69. An opening 70 is provided on the front face of the handle 66 and aligns with the female connection port 54 when the handle is attached to the valve body 48.

The valve body 48 includes a vertically-arranged slot 71 in its front face centered over the female connection port 54. The slot 71 is opened on a front side, and is configured to slidingly receive a slide plate 72. The slide plate 72 includes an opening 74 at its lower end having a lower, narrow portion 76, and an upper, wider portion 78.

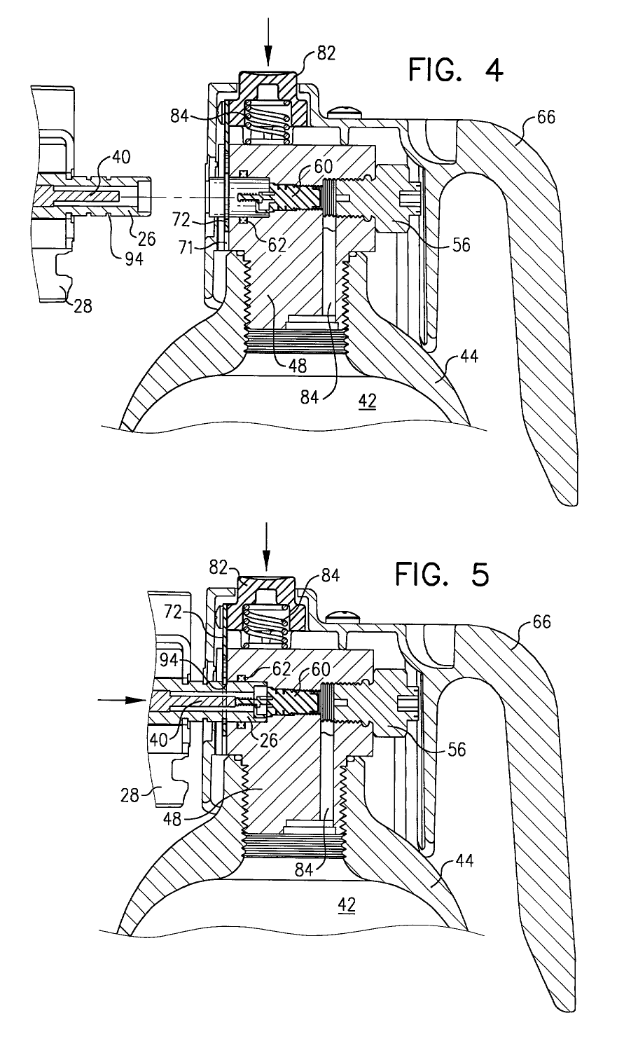

The slide plate 72 is connected, for example by fasteners 80, to a button 82. The button 82 is recessed within the handle 66, and extends through a hole 83 in the upper surface of the handle. The button 82 is mounted for sliding up and down movement within the handle 66. A spring 84 is mounted below the button 82, and biases the button upward. When the button 82 is in this position, the narrowed portion 76 of the slide plate 72 aligns with the front opening of the female connection port 54 (see, e.g., FIG. 1). When the button 82 is depressed against the bias of the spring 84, the wider portion 78 is aligned with the female connection port 54 (FIG. 5). The function of this feature is described below.

The thermal fuse 30 is mounted on the side of the valve body 48. As can be seen in FIG. 8, as with the vent mechanism 56 and the delivery valve mechanism 60, the thermal fuse 30 is in fluid communication with the inside of the tank 42 if the valve body 48 is attached to the tank, e.g., through a bore 84 that extends through the threaded shaft 50 (the fluid communication of the bore 84 with the vent mechanism 56 and the delivery valve mechanism 60 is shown in FIG. 4). The thermal fuse 30 may be mounted in other locations on the valve body 48, such as the top or back sides, but regardless of where mounted, is preferably in fluid communication with the tank 42.

The thermal fuse 30 is basically a closed structure that has a fusible material therein that melts away when a temperature threshold is met. For example, for a metal hydride canister, the threshold may be 275-325° F., or more preferably 290-310° F. These thresholds allow the canister 20 to operate at significant temperatures, but keep the canister 20 at safe operating temperatures (e.g., below 350° F.). After the material fuses away, the fuse is opened, providing a passage through the thermal fuse. In the present invention, opening the passage permits opens a free passageway between the interior of the tank 42, through bore 84 and out of the valve body 48 through the passageway in the thermal fuse. This passage permits the contents of the tank 42 to be opened to atmosphere, and results in exhaust of the gases in the tank when the tank contents are under pressure. In this manner, using the thermal fuse 30, the contents of the tank 28 are released to atmosphere when the canister 20 reaches a high temperature, such as during a fire, helping to prevent unwanted violent chemical reactions or pressures at the elevated temperatures. An example of a thermal fuse that may be used with the invention is described in U.S. Pat. No. 5,762,091, incorporated herein by reference. The fuse material described in this patent is an eutectic alloy, but other materials having similar fusing properties may be used.

The handle 66 extends over the thermal fuse, and serves as a protective covering for the thermal fuse 30. As such, the handle prevents the fuse material from flowing out of the thermal fuse 30.

The details of the manifold 36 are shown in FIG. 3. The illustrated manifold 36 collects the hydrogen from three metal hydride canisters 20 (only one shown in FIG. 3) and channels the hydrogen (e.g., via the conduit 38) to the inlet solenoid valve of, for example, a fuel cell D.C. module (not shown). Each port 90 of the manifold 36 may contain an electrically-operated solenoid valve 28, controlled by a system microprocessor (not shown), to provide individual shut-off capability for each hydride canister 20. In addition, each port 90 of the manifold 36 may additionally contain a check valve (not shown) to prevent back flow of hydrogen in the event that one canister is removed from the system.

In the embodiment shown, the solenoid valves 28 each include a male coupling 26 extending from a distal end, and a plunger 40 (FIG. 4) extending axially within the male coupling. The plunger 40 is connected to the solenoid valve 28 so that actuation of the solenoid for the valve causes the plunger to extend axially. The function of the plunger 40 and the solenoid valve 28 is described further below. The male coupling 26 further includes a circumferential ring indentation 94, the function of which is also described below.

Turning now to FIGS. 4-6, to install the canister 20 onto the male coupling 26, a user grips the handle 66 by the gripping portion 68 and depresses the button 82. Prior to depressing the button 82, the narrow portion 76 of the opening is aligned with the female connection port 54. The narrow portion 76 is too narrow to permit insertion of the male coupling 26. Pressing the button 82 causes the spring 84 to compress, and moves the slide plate 72 down so that the wider portion 78 of the opening 74 is aligned with the female connection port 54. The male coupling 26 may then be inserted through the wider portion 78 and into the female connection port 54. The quad-ring or T-seal 62 provides a sealed interface between the male coupling 26 and the female connection port 54.

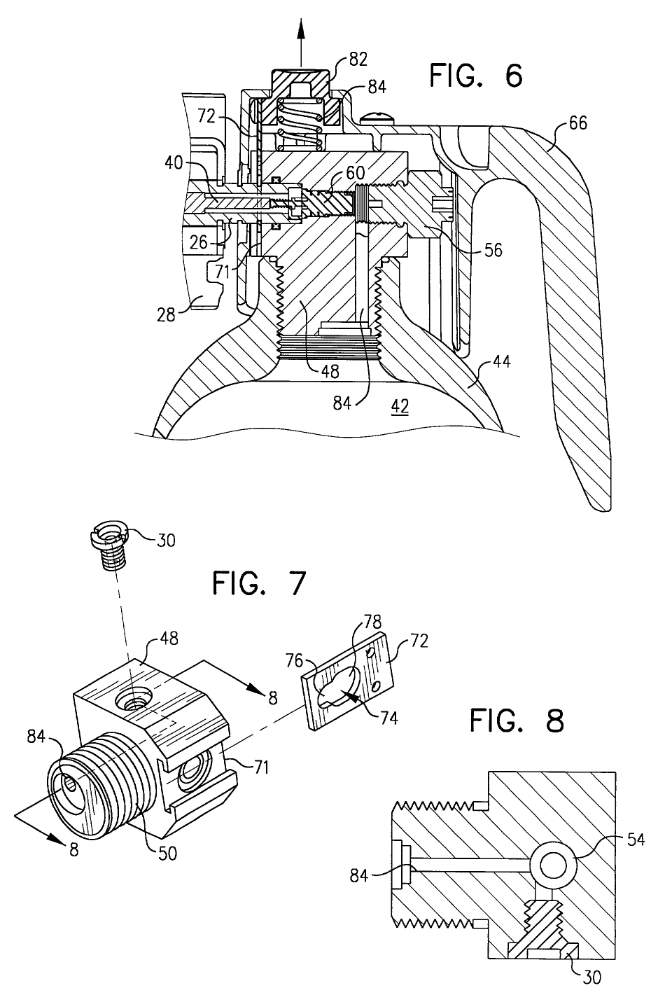

After the male coupling 26 is fully inserted into the female connection port 54, the slide plate 72 is aligned with the circumferential ring indentation 94, and the male coupling is still within the wider portion 78 of the opening 74 (FIG. 5). To lock the male coupling 26 into the female connection port 54, the button 82 is released, and the spring 84 presses the button and the slide plate 72 back to the upper position (FIG. 6). The inner edges of the narrow portion 76 of the opening 74 then lock into the circumferential ring indentation 94 on the male coupling 26. This connection locks the canister 20 into place, and prevents accidental dislodging of the canister from the male coupling 26.

Although the described embodiment utilizes a slide plate 72 and a circumferential ring indentation 94, other latching mechanisms may be used. For example, the male coupling may include a single protrusion that acts as a shoulder that locks behind the slide plate, a rod that extends into a single slot in, or behind a shoulder on, the male coupling, and so forth. To this end, the inserted end of the circumferential ring indentation 94 acts as a shoulder, and the slide plate 72 acts as a stop that slides behind the shoulder, to prevent retraction of the male coupling. The described embodiment of the present invention is advantageous, however, in that the opening for the female connection port 54 is blocked by the slide plate when the button is not depressed, and in that the manufacture of the latching mechanism is relatively inexpensive, yet stable.

When the solenoid for the solenoid valve 28 is activated, the plunger 40 pushes on a valve pin 100 of the delivery valve mechanism 60, thereby opening the valve. This action allows, for example, hydrogen in the canister to flow through the delivery valve mechanism 60 and the solenoid valve 28 and into the manifold 36. Hydrogen gas would be prevented from entering the manifold 36, or leaving the canister 20 unless the solenoid of the solenoid valve 28 has been activated. Likewise, gas could not enter the manifold 36 unless a canister 20 is properly placed in connection to the male coupling 26, because the solenoid valve 28 should be properly aligned so that the plunger 40 can engage the valve pin 40. If a system fault is detected, the solenoid valve 28 may be deactivated at each canister 20, shutting off the flow of fuel. Thus, the delivery valve mechanism 60 may be automatically and remotely controlled by control electronics connected to the solenoid valve 28.

The thermal fuse 30 of the present invention provides a safety mechanism designed to relieve pressure in the canister 20 when the temperature of the canister exceeds a threshold, for example, as a result of fire or direct heating. In addition, the quick-release connection provided by the latching assembly 22 provides a mechanism for securely and reliably attaching the canister 20 to a fuel delivery system, such as a manifold for a fuel cell. Moreover, the location of the button 82 relative to the gripping portion 66 of the handle 62 permits a user to grip the handle and actuate the button with the same hand. In this manner, the canister 20 may be installed on the male coupling 26 with one hand.

Variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

What is claimed is:

1. A pressurized gas canister, comprising:
a tank for containing a high pressure material;
a female connection port in fluid communication with the tank and being configured to fit onto a male coupling, and further comprising a latch mechanism for selectively locking a male coupling in the female connection port; and
a thermal fuse in fluid communication with the tank, the thermal fuse configured to maintain an opening closed when the temperature of the thermal fuse is below a temperature threshold, and to open the opening when the thermal fuse exceeds the temperature threshold.

2. The pressurized gas canister of claim 1, wherein the high pressure material comprises metal hydride.

3. The pressurized gas canister of claim 2, wherein the tank comprises an opening, and further comprising a valve body mounted in the opening, and wherein the thermal fuse is mounted in the valve body.

4. The pressurized gas canister of claim 3, further comprising a relief valve mounted in the valve body and in fluid communication with the tank.

5. The pressurized gas canister of claim 4, further comprising a delivery valve mechanism mounted in the valve body and in fluid communication with the tank.

6. The pressurized gas canister of claim 3, further comprising a delivery valve mechanism mounted in the valve body and in fluid communication with the tank.

7. The pressurized gas canister of claim 1, wherein the temperature threshold comprises 275-325° F.

8. The pressurized gas canister of claim 7, wherein the temperature threshold is 290-310° F.

9. The pressurized gas canister of claim 1, wherein the thermal fuse comprises an eutectic alloy.

10. The pressurized gas canister of claim 1, further comprising a handle extending over the thermal fuse, and wherein the handle comprises a protective cover for the thermal fuse.

11. The pressurized gas canister of claim 1, wherein the latching mechanism comprises a lock that is movable between first and second positions, in the first position the lock extends behind a shoulder on a male coupling in the female connection port so as to block retraction of the male coupling from the female connection port, and in the second position the lock is removed from behind the shoulder.

12. The pressurized gas canister of claim 11, wherein at least a portion of the lock extends across an opening for the female connection port when the lock is in the first position, whereby insertion of a male coupling into the female connection port is at least partially blocked by the lock when the lock is in the first position.

13. The pressurized gas canister of claim 11, wherein the lock comprises a plate having an opening therethrough, the opening having edges therearound, and wherein, in the first position, at least a portion of the edges are aligned behind the shoulder to block retraction of the male coupling.

14. The pressurized gas canister of claim 13, wherein the opening in the plate includes a wider portion and a narrow portion, and wherein in the second position the wider portion is aligned with the female connection port to permit passage of a male coupling therethrough, and wherein in the first position at least a part of the narrow portion is aligned with the female connection port to block insertion of a male coupling and retraction of an inserted male coupling.

15. The pressurized gas canister of claim 14, further comprising a button attached to the plate, actuation of the button causing the lock to move between the first and second positions.

16. The pressurized gas canister of claim 15, wherein the button is spring-biased to the first position.

17. The pressurized gas canister of claim 15, further comprising a handle mounted on the canister and adjacent the button, whereby a user can actuate the button with one hand while holding the canister by the handle with the one hand.

18. A pressurized gas canister, comprising:
a tank for containing a high pressure material; and
a female connection port in fluid communication with the tank and being configured to fit onto a male coupling, and further comprising a latch mechanism for selectively locking a male coupling in the female connection port.

19. The pressurized gas canister of claim 18, wherein the latching mechanism comprises a lock that is movable between first and second positions, in the first position the lock extends behind a shoulder on a male coupling in the female connection port so as to block retraction of the male coupling from the female connection port, and in the second position the lock is removed from behind the shoulder.

20. The pressurized gas canister of claim 19, wherein at least a portion of the lock extends across an opening for the female connection port when the lock is in the first position, whereby insertion of a male coupling into the female connection port is at least partially blocked by the lock when the lock is in the first position.

21. The pressurized gas canister of claim 19, wherein the lock comprises a plate having an opening therethrough, the opening having edges therearound, and wherein, in the first position, at least a portion of the edges are aligned behind the shoulder to block retraction of the male coupling.

22. The pressurized gas canister of claim 21, wherein the opening in the plate includes a wider portion and a narrow portion, and wherein in the second position the wider portion is aligned with the female connection port to permit passage of a male coupling therethrough, and wherein in the first position at least a part of the narrow portion is aligned with the female connection port to block insertion of a male coupling, and retraction of an inserted male coupling.

23. The pressurized gas canister of claim 22, further comprising a button attached to the plate, actuation of the button causing the lock to move between the first and second positions.

24. The pressurized gas canister of claim 23, wherein the button is spring-biased to the first position.

25. The pressurized gas canister of claim 23, further comprising a handle mounted on the canister and adjacent the button, whereby a user can actuate the button with one hand while holding the canister by the handle with the one hand.
